(19) United States
(12) Patent Application Publication
(10) Pub. No.: US 2021/0046413 A1
(43) Pub. Date: Feb. 18, 2021

(54) HIGH PERFORMANCE DENSITY ELEMENT WITH ANGLE BETWEEN INLET FLOW AND OUTLET FLOW

(71) Applicant: CUMMINS FILTRATION IP, INC., Columbus, IN (US)

(72) Inventors: Ming Ouyang, Short Hills, NJ (US); Christopher E. Holm, Madison, WI (US); Scott W. Schwartz, Cottage Grove, WI (US); Matthew Louison, McFarland, WI (US); Miao Li, McFarland, WI (US); Jeremiah Cupery, Madison, WI (US); Mark P. Adams, Madison, WI (US); Shantanu Sanjay Ghatnekar, Pune (IN)

(73) Assignee: CUMMINS FILTRATION IP, INC., Columbus, IN (US)

(21) Appl. No.: 17/044,529

(22) PCT Filed: May 7, 2019
(86) PCT No.: PCT/US2019/031132

§ 371 Date: Oct. 1, 2020

Related U.S. Application Data
(60) Provisional application No. 62/667,978, filed on May 7, 2018.

(51) Int. Cl. B01D 46/10; B01D 46/00; B01D 46/52; F02M 35/02; F02M 35/024

(52) U.S. Cl. CPC B01D 46/10; B01D 46/0039; F02M 35/02466; F02M 35/0201; F02M 35/02416; B01D 46/523

(57) ABSTRACT

Filter media including one or multiple sheets of filter media, an upstream inlet, and a downstream outlet. A pleat pack can be formed by alternately folding a flat sheet along pleat fold lines with a high media surface density. The flat sheet of filter media may include a separation geometry feature or separation mechanism that maintains a separation distance between adjacent pleats of the filter media. A separation geometry can comprise one or more embossments forming a raised surface, an inlet spacer mesh and/or an outlet spacer mesh positioned between adjacent pleats, and/or an adhesive bead. The upstream inlet receives dirty fluid along a first direction and the downstream outlet discharges clean fluid along a second direction substantially not parallel to the first direction. The filter element defines an angle between the inlet and outlet flow, allowing large dust particles to move out of the media pack due to inertia.

CROSS-REFERENCE TO RELATED PATENT APPLICATIONS

This application claims priority to U.S. Provisional Patent Application No. 62/667,978 filed on May 7, 2018, which is incorporated herein by reference in its entirety.

### TECHNICAL FIELD

The present application relates filter media, filter media packs, and filter elements for filtering fluids. More particularly the present application relates to filter media pack with an angle between inlet flow and outlet flow.

### BACKGROUND

Fluid streams, such as gases and liquids, carry contaminant material therein in many instances. It is often desirable to filter some or all of the contaminant material from fluid stream. The present technology applies to but is not limited to internal combustion engines. Internal combustion engines generally combust a mixture of fuel (e.g., gasoline, diesel, natural gas, etc.) and air. Many or all of the fluids passing through the internal combustion engine are filtered to remove particulate and contaminants from the fluids prior to entering the internal combustion engine. For example, prior to entering the engine, intake air is typically passed through a filter element to remove contaminants (e.g., particulates, dust, water, etc.) from the intake air prior to delivery to the engine. The filter media of the filter element captures and removes particulate from the intake air passing through the filter media. As the filter media captures and removes particulate, the restriction of the filter media increases. The filter media has a dust holding capacity that defines the amount of particulate that the filter media can capture at a specified pressure drop without the need for replacement. After the dust holding capacity of the filter media is reached, the filter element may require replacement. Filter elements are not limited to filtering fluids in internal combustion engines and can be used to filter fluids in various other applications.

### SUMMARY

Various example embodiments relate to filter media and filter elements containing the filter media. One example embodiment includes filter media including a flat sheet of filter media, an upstream inlet, and a downstream outlet. The flat sheet is alternately folded along a plurality of pleat fold lines, the flat sheet of filter media comprising a plurality of embossments, each of the embossments forming a raised surface that maintains a separation distance between adjacent pleats of the filter media. The upstream inlet receives dirty fluid along a first direction, and the downstream outlet discharges clean fluid along a second direction, the second direction substantially not parallel to the first direction.

Another example embodiment includes filter media including a flat sheet of filter media, an upstream inlet, and a downstream outlet. The flat sheet is alternately folded along a plurality of pleat fold lines, the flat sheet of filter media comprising a separation geometry feature or a separation mechanism that maintains a separation distance between adjacent pleats of the filter media. The upstream inlet receives dirty fluid along a first direction and the downstream outlet discharges clean fluid along a second direction, an angle between the second direction and the first direction less than 180 degrees and greater than zero degrees.

Another example embodiment includes filter media including a flat sheet of filter media that is alternately folded along a plurality of pleat fold lines, a first upstream inlet face receiving dirty fluid along a first inlet direction and a second upstream inlet face receiving dirty fluid along a second inlet direction. The first upstream inlet face and the second upstream inlet face combine to form an inlet of the filter media. The filter media also includes a first downstream outlet face discharging clean fluid along a first outlet direction and a second downstream outlet face discharging clean fluid along a second outlet direction. The first downstream outlet face and the second downstream outlet face combine to form an outlet of the filter media. The first inlet direction and the first outlet direction are substantially parallel to each other. The filter media may also include an intermediate seal member positioned between the inlet and the outlet.

Another example embodiment includes filter media including a first set of corrugated sheets positioned in a first direction and a second set of corrugated sheets positioned in a second direction. The first set of corrugated sheets and the second set of corrugated sheets are alternatingly stacked on each other. The filter media also includes a first set of flow channels formed along the first direction and at least partially sealed, where incoming dirty fluid enters and flows through the first set of flow channels and through the second set of corrugated sheets in a third direction. The filter media also includes a second set of flow channels formed along the second direction and at least partially sealed, where clean filtered fluid exits the filter media through the second set of flow channels.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 shows a perspective view of a filter element including filter media according to an example embodiment.

FIG. 2 shows a perspective view of filter media according to an example embodiment.

FIG. 3 shows a perspective view of the filter element of FIG. 1 according to an example embodiment.

FIG. 4 shows a top view of the filter element of FIG. 1 according to an example embodiment.

FIG. 5 shows a front view of the filter element of FIG. 1 according to an example embodiment.

FIG. 6 shows a perspective view of the filter element of FIG. 1 according to an example embodiment.

FIG. 7 shows a perspective view of a pleat end frame for use with the filter element of FIG. 6 according to an example embodiment.

FIG. 8 shows a perspective view of the filter element of FIG. 1 according to an example embodiment.

FIG. 9 shows a perspective view of a pleat dividing frame for use with the filter element of FIG. 8 according to an example embodiment.

FIG. 10 shows a perspective view of the filter element of FIG. 1 according to an example embodiment.

FIG. 11 shows a perspective view of the filter element of FIG. 1 according to an example embodiment.

FIG. 12 shows a perspective view of filter media according to another example embodiment.

FIG. 13 shows a front view of an inlet spacer mesh structure for use with the filter element of FIG. 1 according to an example embodiment.

FIG. 14 shows a cross-sectional view of an inlet spacer mesh structure for use with the filter element of FIG. 1 according to an example embodiment.

FIG. 15 shows a front view of an outlet spacer mesh structure for use with the filter element of FIG. 1 according to an example embodiment.

FIG. 16 shows a cross-sectional view of an outlet spacer mesh structure for use with the filter element of FIG. 1 according to an example embodiment.

FIG. 17 shows a perspective view of filter media having an in-line design, according to an example embodiment.

FIG. 18 shows a perspective view of filter media having an angled flow design, according to an example embodiment.

FIG. 19 shows a perspective view of filter media having a 3-3 type flow design, according to an example embodiment.

FIG. 20 shows a perspective view of filter media having a flex flow design, according to an example embodiment.

FIG. 21 shows a perspective view of filter media having a flex flow design, according to an example embodiment.

FIG. 22 shows a schematic perspective end view of filter media having a flat or symmetrical seal, according to an example embodiment.

FIG. 23 shows a schematic perspective side view of filter media having a flat or symmetrical seal, according to an example embodiment.

FIG. 24 shows a schematic view of a seal bead pattern for a direct flow element, according to an example embodiment.

FIG. 25 shows a schematic view of a seal bead pattern for a flex flow element, according to an example embodiment.

FIG. 26 shows a schematic view of filter media having an angled seal on a pleat end, according to an example embodiment.

FIG. 27 shows a schematic view of filter media having an angled seal on a pleat end, according to an example embodiment.

FIG. 28 shows a schematic view of filter media having an angled seal on a pleat face, according to an example embodiment.

FIG. 29 shows a schematic view of filter media having an angled seal on a pleat face, according to an example embodiment.

FIG. 30 shows a bar graph of dust capacity for various types of filter media, according to an example embodiment.

FIG. 31 shows a line graph of pressure drop relative to flow rate for various types of filter media, according to an example embodiment.

FIGS. 32-37 show a schematic view of various filter elements having differing fluid flow arrangements.

FIG. 38 shows a perspective view of filter media having stacked corrugated sheets, according to an example embodiment.

FIG. 39 shows a perspective view of a portion of the filter media of FIG. 38, according to an example embodiment.

FIG. 40 shows a perspective view of a portion of the filter media of FIG. 38.

FIG. 41 shows a perspective view of a portion of the filter media of FIG. 38.

FIG. 42 shows an isolated single corrugation volume of the filter media of FIG. 38.

FIG. 43 shows an analysis of a total pressure contour of an inlet side of the filter media of FIG. 38.

FIG. 44 shows an analysis of a total pressure contour of an outlet side of the filter media of FIG. 38.

FIG. 45 shows an analysis of a total pressure contour of a combined inlet and outlet model of the filter media of FIG. 38.

FIG. 46 shows an analysis of a velocity magnitude contour of an inlet side of the filter media of FIG. 38.

FIG. 47 shows an analysis of a velocity magnitude contour of an outlet side of the filter media of FIG. 38.

FIG. 48 shows an analysis of a velocity magnitude contour of a combined inlet and outlet model of the filter media of FIG. 38.

FIG. 49 shows streamlines visualized at a corner of the filter media of FIG. 38.

FIG. 50 shows a perspective view of filter media having stacked diagonal corrugated sheets, according to an example embodiment.

FIG. 51 shows a perspective view of the filter media of FIG. 50 with seals.

FIG. 52 shows a perspective view of a portion of the filter media of FIG. 50.

FIG. 53 shows a schematic diagram of dust stratification, where large dust particles are carried out of pleat pack while air with small dust particles flow to the filter media.

### DETAILED DESCRIPTION

Referring to the figures generally, high density elements employing filter media comprising one or more separation geometry features or one or more separation mechanisms are described. In some arrangements, filter media having embossments formed in the media are described. In some arrangements, the filter media is pleated filter media. The filter media includes a pattern of embossments that help maintain separation between adjacent layers of the filter media. The embossments allow for two adjacent media layers (e.g., mating surfaces of the filter media) to remain separated, thereby increasing dust holding capacity and lowering pressure drop over similarly configured filter media not having the embossments. In addition, the filter element described herein defines an angle between the inlet and outlet fluid flow, allowing large dust particles to move out of the media pack of the filter element or to a location within the media pack which is out of the general path of airflow, which leads to increased dust holding capacity and filter life. The filter media described herein may include a high density pleated media pack. For high density media packs, the upstream (or downstream) media surface density is defined as equal to the upstream (or downstream) media area divided by the volume of the filter media pack. For high density media packs, the upstream (or downstream) media surface density is approximately equal to the number of pleats per inch for pleated media pack multiplied by a factor of two. As an example, the filter media described herein may include a high density pleated media pack of at least 7 pleats per inch, which approximately translates to an upstream (or downstream) media surface density of 14 per inch. According to another example, the filter media described herein may include a high density pleated media pack of 9 pleats per inch, which approximately translates to an upstream (or downstream) media surface density of 18 per inch.

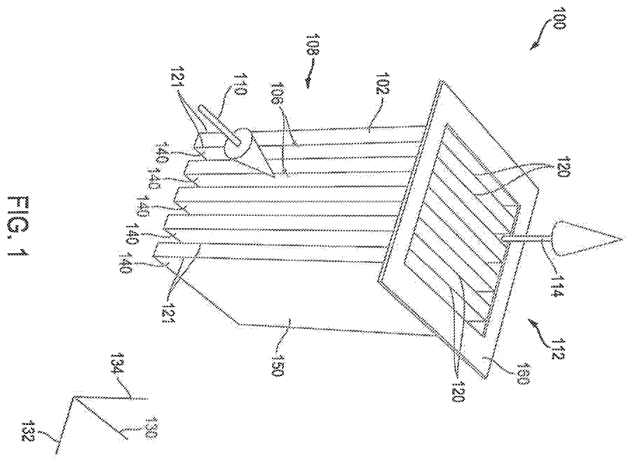

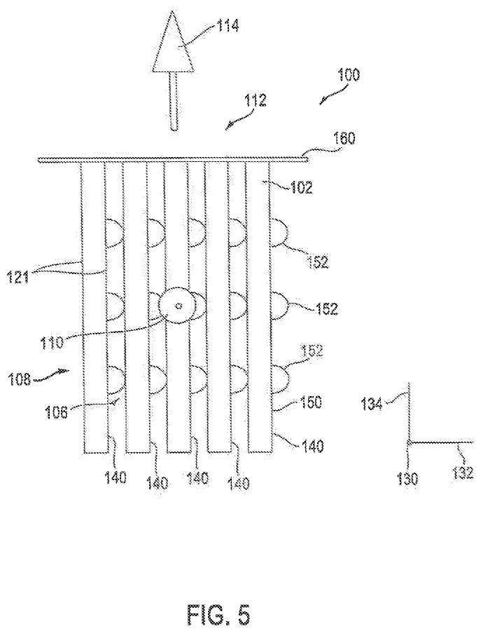

Referring to FIGS. 1-5, a filter element 100 having filter media 102 is shown according to an example embodiment. The filter media 102 is a pleated filter media. The filter media 102 includes a flat sheet 150 that is alternately folded along pleat fold lines 120 to form the filter media 102. Although shown as rectangular pleats, the pleat shapes may vary. Each flat sheet 150 extends axially along the full axial length of the filter element 100 along axial direction 130, and extends laterally along the full lateral width along lateral direction 134 across and sealing the channels to prevent bypass of dirty upstream air to clean downstream air without passing through and being filtered by a wall segment 140. In some arrangements, each flat sheet 150 is generally rectiplanar along a plane defined by axial direction 130 and lateral direction 134. In some arrangements, the flat sheet 150 is held in the folded or pleated position to form a pleat block or pack. The fold lines 120 extend axially along an axial direction 130. The filter media 102 is also shown to include one or more pleat edge seals 121 extending along a lateral direction. In some arrangements, the media surface density is at least 10 per inch or the pleat concentration is at least 5 pleats per inch. In other arrangements, the media surface density is at least 14 per inch or the pleat concentration is at least 7 pleats per inch. In yet another arrangement, the media surface density is at least 18 per inch or the pleat concentration is at least 9 pleats per inch.

The filter media 102 comprises a plurality of filter media wall segments 140 extending between the fold lines 120. The wall segments 140 extend axially and define axial flow channels 106 therebetween. The filter media 102 has an upstream inlet 108 receiving incoming dirty fluid (as shown at arrow 110), and a downstream outlet 112 discharging clean filtered fluid as shown at arrow 114. In some arrangements, the upstream inlet 108 is a first side of the filter media 102 and the downstream outlet 112 is a second side of the filter media 102. In other arrangements, the upstream inlet 108 is a second side of the filter media 102, and the downstream outlet 112 is a first side of the filter media 102.

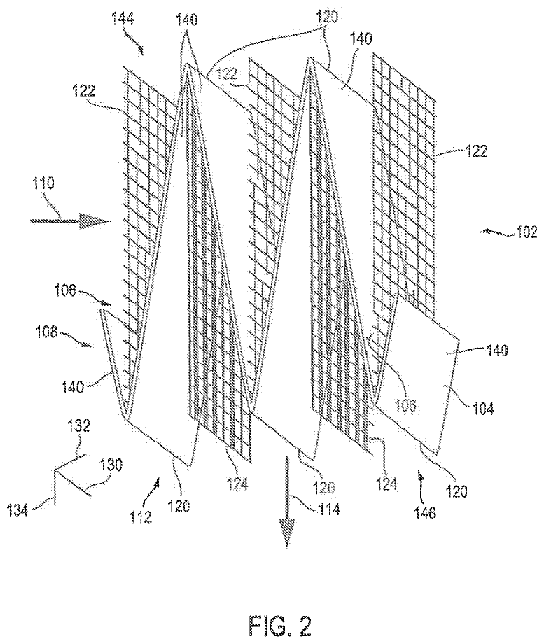

Referring to FIGS. 1-2, incoming dirty fluid to be filtered flows along axial direction 130 into flow channels 106 at upstream inlet 108 and passes laterally along lateral direction 134 through the filter media wall segments 140, and as clean filtered fluid (represented by arrow 114) through flow channels 106 at downstream outlet 112. The angle (e.g., a 90-degree angle) between the inlet and outlet flow allows large dust particles to move out of the filter media 102 and be collected elsewhere, which leads to increased dust holding capacity and filter life. In addition, the filter housing pressure drop is minimized due to the avoidance of fluid flow turning at a high velocity. The filter media can also be packed into an otherwise void volume within the housing and dust stratification and storage at spaces with no blockage of media surface may eliminate the need for inertial separators. Furthermore, it is not necessary to use the filter media in a cylindrically-shaped housing, which may be beneficial because the cuboid shape allows for more filtration area. In some arrangements, at least 20 percent of large dust particles misses the downstream outlet 112 allowing dust to move out of the media pack when the fluid flows straight from the upstream inlet in the direction of the incoming fluid flow. In other arrangements, at least 30 percent of the large dust particles misses the downstream outlet 112. In yet another arrangement, at least 50 percent of the large dust particles misses the downstream outlet 112.

In some arrangements, the flow through the filter media 102 is reversed from the above described flow direction. For example, air to be filtered can flow in the opposite direction defined by arrows 110 and 114 such that air to be filtered flows into what is represented as the downstream outlet 112, through the filter media 102, and out what is represented as the upstream inlet 108. In such arrangements, the structure of the filter media 102 remains the same, but the flow through the media 102 is reversed.

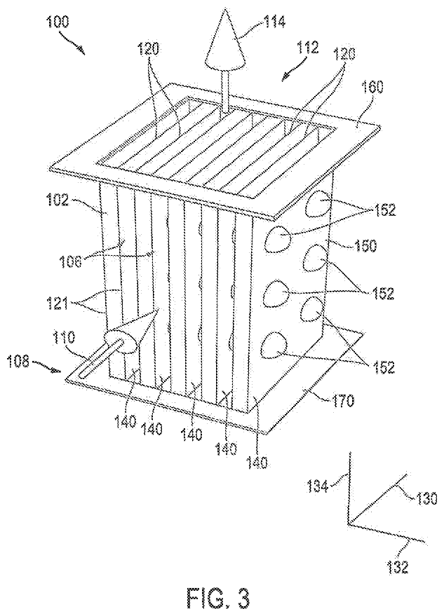

As shown in FIG. 3, each flat sheet 150 includes a plurality of embossments 152 (e.g., separation geometry features, separation mechanisms). The embossments 152 form a raised surface with respect to the generally rectiplanar surface of the flat sheet 150. Although shown as being circular in shape, the embossments 152 can have any shape (e.g., oval, triangular, square, rectangular, etc.). The embossments 152 extend in a direction that is perpendicular to the pleat fold lines 120. When the filter media 102 is layered, folded, or coiled to form a pleat block, each of the flat sheets 150 rests against the raised surface of the embossments 152 of another flat sheet 150 thereby creating a separation distance between each flat sheet 150 and forming flow channels 106. The separation distance increases the dust holding capacity of the filter media 102 and reduces the restriction of the filter media 102, which results in a lower pressure drop and increased capacity compared to similar filter media without the embossments. By using the embossments 152, a smaller media blind-off area may also exist.

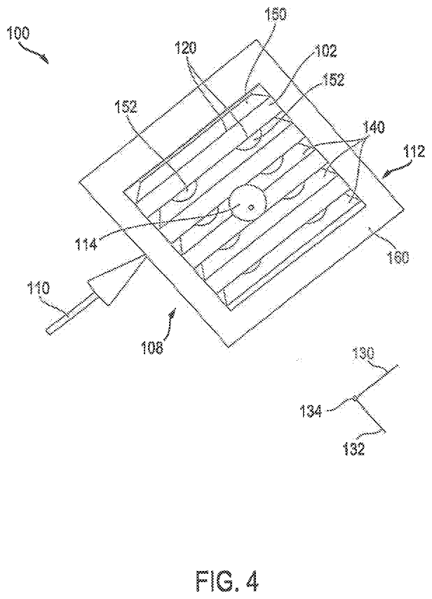

As shown in FIGS. 3-4, the filter element 100 also includes a sealing surface 160 proximate the downstream outlet 112. The sealing surface 160 is structured to seal against a filter housing the filter element 100 may be positioned within.

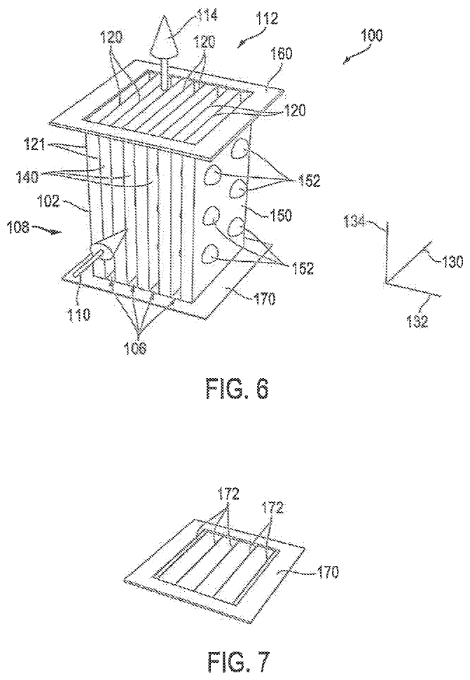

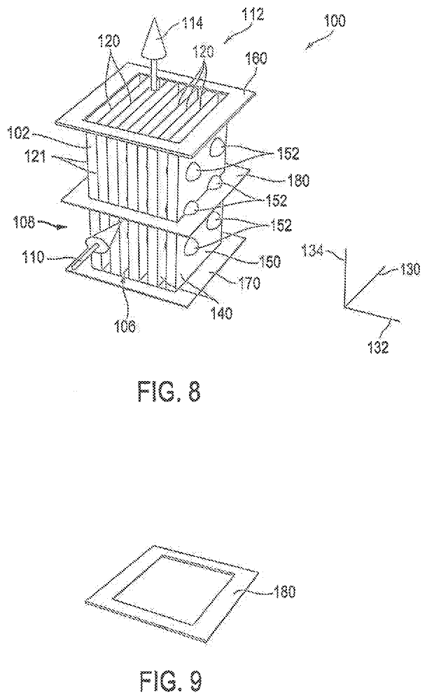

Referring to FIGS. 6-7, in some embodiments, the filter element 100 also includes a pleat end frame 170. The pleat end frame 170 acts to stabilize the filter media 102. The pleat end frame 170 is positioned proximate an opposite lateral end (e.g., opposite along the lateral direction 134) from the downstream outlet 112. In some embodiments, the pleat end frame 170 includes guides 172 inserted just inside the pleat tips and bonded with the pleat end frame 170. Referring to FIGS. 8-9, the filter element 100 also includes a pleat dividing frame 180. The pleat dividing frame 180 further stabilizes the filter media 102. As shown in FIG. 8, the pleat dividing frame 180 is positioned approximately midway between the downstream outlet 112 and the opposite lateral end of the filter element 100.

In other arrangements, a three-dimensional structure may be installed (not shown). In some arrangements, a pleat end frame similar to the pleat end frame 170 with guides similar to the guides 172 shown in FIG. 7 may be installed at the outlet plane (e.g., at downstream outlet 112). The pleat end frame positioned at the outlet plane may be bound with pleat end frame 170 positioned at the opposite lateral end to stretch the filter media 102 out. This binding can be done without obstructing the fluid flow through the filter media 102. The guides used downstream and upstream may be differently sized and shaped for volume asymmetry. This arrangement could allow for additional volume upstream for dust loading.

In some arrangements, to avoid fluid flow from entering the flow channels 106 from a further end of the flow channel 106 from the opposite direction, the upstream inlet 108 is sealed to ensure stratification effects as shown in FIG. 53 and described further herein. Alternatively, a structure near the further end of the upstream inlet 108 may be used to limit or eliminate air flow coming in from the opposite direction, to allow for stratification effects.

In some arrangements, the flow direction of the discharged clean filtered fluid shown by arrow 114 is substantially opposite to the direction of gravity. In other arrangements, the flow direction of the incoming dirty fluid shown by arrow 110 is substantially along the direction of gravity. When referred to herein, the term “substantially” with regard to the description of direction or angles of fluid flow or placement of various components relative to each other refers to an angle within ±5 degrees from the referenced direction or angle. When referred to herein, the term “substantially not parallel” refers to a direction or angle at least 1 degree away from parallel. These arrangements allow for dust collected due to stratifications (e.g., large dust particles that gather at the far end of the media pack in the inlet flow direction or direction of arrow 110) to not fall back to the filter media 102 section. In addition, these arrangements allow for dust collected due to stratifications to gather closer to the further corner from the inlet flow direction (or direction of arrow 110). Referring to FIG. 53, a schematic diagram showing dust stratification 700 is shown, according to an example embodiment. As shown, air flow with dust particles 710 enters a flow channel of the media 702 at an inlet 704. The air flow separates into an air flow with small dust particles 714 and large dust particles 712. The large dust particles 712 move through the flow channel and gather at the far end of the media pack and do not reenter the air flow. The small dust particles 714 turn towards the filter media 702 and be filtered by the filter media 702 toward an outlet.

In some arrangements, because the flow channels 106 in the upstream inlet section 144 and flow channels 106 in the downstream outlet section 146 are associated with two different directions of fluid flow, ratios of inlet flow length to outlet flow length may be ideal between 1:2 and 2:1. In some arrangements, for high density elements of 10 pleats per inch (PPI) or higher, the element size may be ideal at approximately 300 millimeters (mm) by 300 mm in the inlet flow and outlet flow directions (e.g., directions shown by arrows 110, 114, respectively). For an alternate flow arrangement, fluid flow may enter the filter media 102 from multiple locations and directions, and the optimal filter element size can be increased and/or the optimal shape of the filter element can be different.

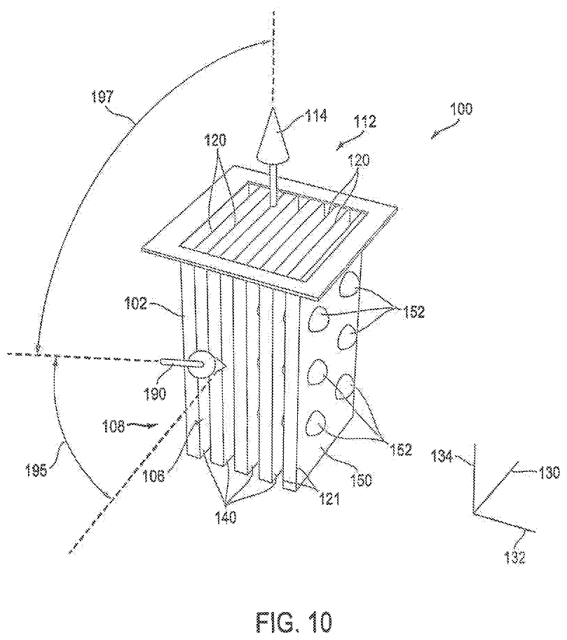

Referring to FIG. 10, in some arrangements, the filter media 102 has an upstream inlet 108 receiving incoming dirty fluid as shown at arrow 190, and a downstream outlet 112 discharging clean filtered fluid as shown at arrow 114. Incoming dirty fluid 190 to be filtered flows at an angle 195 relative to the axial direction 130 into flow channels 106 at upstream inlet 108 and passes through the filter media 102 along lateral direction 134, and is discharged as clean filtered fluid 114 through flow channels 106 at downstream outlet 112. In this arrangement, the direction of the incoming dirty fluid as shown by at arrow 190 is at an angle 197 relative to the direction of the discharged clean filter fluid as shown at arrow 114. The angle 197 is greater than zero degrees. In some arrangements, the angle 197 is greater than 90 degrees.

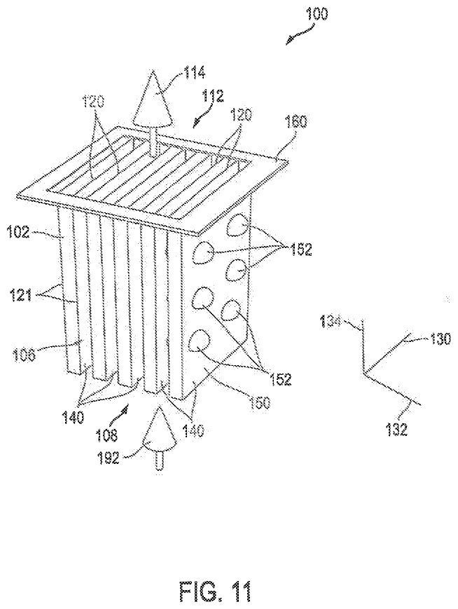

Referring to FIG. 11, in some arrangements, the filter media 102 has an upstream inlet 108 receiving incoming dirty fluid as shown at arrow 192, and a downstream outlet 112 discharging clean filtered fluid as shown at arrow 114. Incoming dirty fluid 192 to be filtered flows along lateral direction 134 into flow channels 106 at upstream inlet 108 and passes through the filter media 102 along lateral direction 134, and is discharged as clean filtered fluid 114 through flow channels 106 at downstream outlet 112. In this arrangement, the fluid flow is substantially in-line.

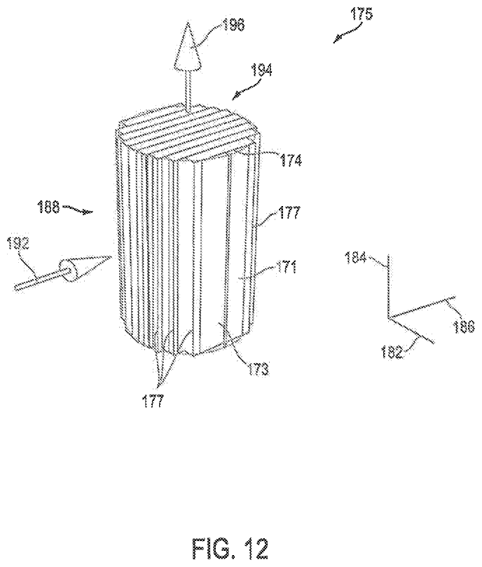

Referring to FIG. 12, a filter element 175 including filter media 171 is shown according to another example embodiment. The filter element 175 is substantially cylindrical in shape. The filter media 171 is a pleated filter media. The filter media 171 includes a flat sheet 173 that is alternately folded along pleat fold lines 174 to form the filter media 171. Although shown as rectangular pleats, the pleat shapes may vary. The pleat heights vary across the transverse direction 182. Each flat sheet 173 extends axially along the full axial length of the filter element 175 along axial direction 186, and extends laterally along the full lateral width along lateral direction 184. In some arrangements, each flat sheet 173 is generally rectiplanar along a plane defined by axial direction 186 and lateral direction 184. In some arrangements, the flat sheet 173 is held in the folded or pleated position to form a pleat block. The fold lines 174 extend axially along an axial direction 186.

The filter media 171 comprises a plurality of filter media wall segments 240 extending between the fold lines 174. The wall segments 177 extend axially and define axial flow channels therebetween. The filter media 171 has an upstream inlet 188 receiving incoming dirty fluid as shown at arrow 192, and a downstream outlet 194 discharging clean filtered fluid as shown at arrow 196.

Still referring to FIG. 12, incoming dirty fluid 192 to be filtered flows along axial direction 186 into the filter media 171 at upstream inlet 188 and passes laterally along lateral direction 184 through the filter media wall segments 177, and is discharged as clean filtered fluid 196 at downstream outlet 194. In addition, the filter housing pressure drop is minimized due to the avoidance of fluid flow turning at a high velocity. The filter media can also be packed into an otherwise void volume within the housing.

Referring back to FIG. 2, a plurality of inlet spacer mesh structures 122 are positioned in the upstream inlet section 144 of axial flow channels 106 and a plurality of outlet spacer mesh structures 124 are positioned in the downstream outlet section 146 of axial flow channels 106. The lateral direction 134 is perpendicular to axial direction 130 and is perpendicular to transverse direction 132.

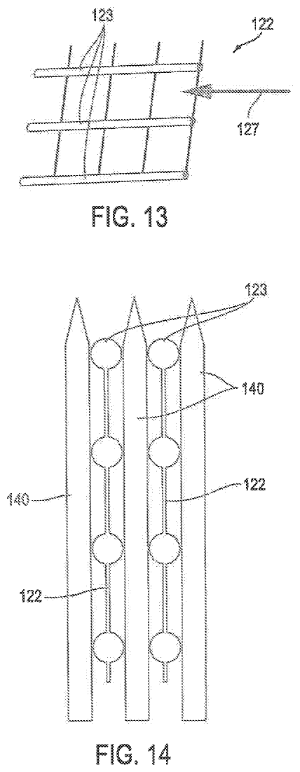

Referring to FIGS. 13-14, the inlet spacer mesh structure 122 is shown according to an example embodiment. The inlet spacer mesh structure 122 includes inlet main strands 123 and inlet connecting strands 133. The inlet connecting strands 133 connect the inlet main strands 123 to each other. The inlet main strands 123 run substantially parallel to the inlet flow direction 127 through the inlet spacer mesh structure 122. In some arrangements, the inlet connecting strands 133 are approximately 0.25 mm in diameter. In some arrangements, the spacing formed by the inlet spacer mesh structure 122 (e.g., the space between the inlet main strands 123 and the inlet connecting strands 133) is approximately 12 mm by 12 mm. In other arrangements, other sizes and shapes of grid spacing can be used. In some arrangements, the inlet main strands 123 are larger in diameter than the outlet main strands 125 to allow for greater upstream dust collection volume.

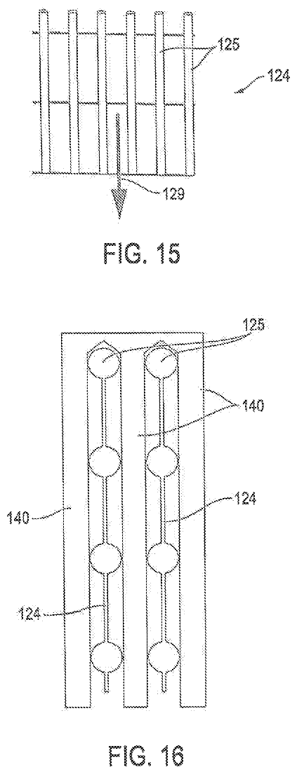

Referring to FIGS. 15-16, the outlet spacer mesh structure 124 is shown according to an example embodiment. The outlet spacer mesh structure 124 includes outlet main strands 125 and outlet connecting strands 135. The outlet connecting strands 135 connect the inlet main strands 125 to each other. The outlet main strands 125 run substantially parallel to the outlet flow direction 129 through the outlet spacer mesh structure 124. The outlet main strands 125 run substantially perpendicular to the inlet main strands 123. In some arrangements, the outlet connecting strands 135 are approximately 0.25 mm in diameter. In some arrangements, the spacing formed by the outlet spacer mesh structure 124 (e.g., the space between the outlet main strands 125 and the outlet connecting strands 135) is approximately 6 mm by 12 mm. A tighter grid spacing may be necessary on the outlet spacer mesh structure 124 than on the inlet spacer mesh structure 122 to prevent collapse of the structure 124. In other arrangements, other sizes and shapes of grid spacing can be used.

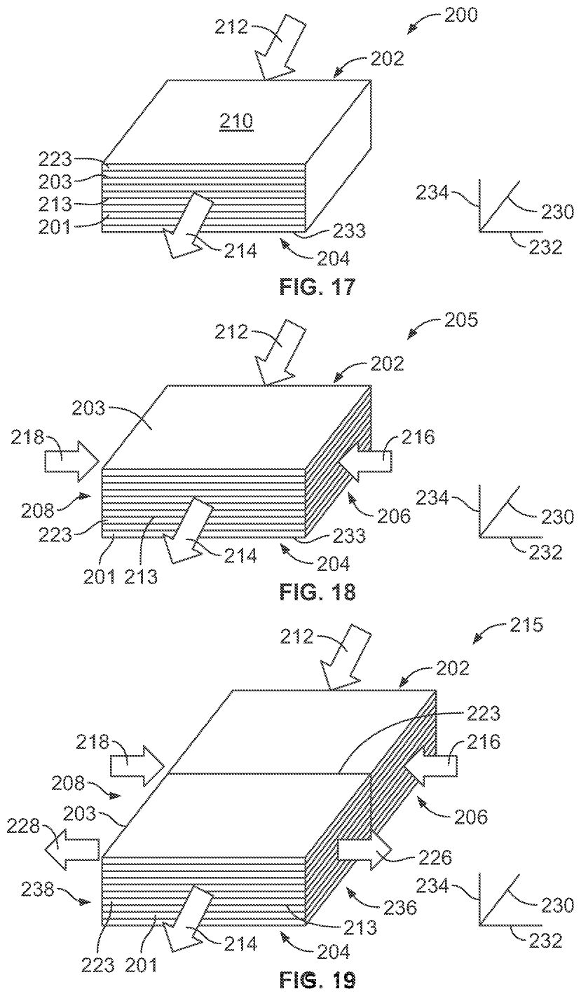

Referring to FIGS. 17-21, various filter elements having filter media 201 are shown according to example embodiments. Using the various filter elements shown, air may enter and exit the media pack at a variety of positions, providing greater flexibility in the air cleaner housing design and positioning of the inlet and outlet connections. The filter media 201 is a pleated filter media. The filter elements 200 include seals at varying positions at least partially sealing the pleats of the filter media 201 such that a portion of each pleat edge is exposed to an upstream (dirty) side and the remaining portion is exposed to a downstream (clean) side. The pleats may be alternately and partially sealed, creating flow through pleats on both the upstream side and the downstream side of the media pack, optionally including an angled seal plane through the media pack. In various embodiments, the filter media 201 may also include media pleat spacing features which may include, but are not limited to, adhesive spacer beads or dots, embossed features in the media, and mesh or open foam intermediate layers. The spacing features allow air to flow crosswise through the pleat. The pleat spacers may help maintain uniform pleat spacing and prevent pleat collapse due to deflection from differential pressure during flow.

The filter media 201 includes a flat sheet 203 that is alternately folded along pleat fold lines 213 to form the filter media 201. Although shown as rectangular pleats, the pleat shapes may vary. Each flat sheet 203 extends axially along the full axial length of the filter element 200 along axial direction 230, and extends laterally along the full lateral width along lateral direction 232 across and sealing the channels to prevent bypass of dirty upstream air to clean downstream air without passing through and being filtered by the filter media 201. In some arrangements, each flat sheet 203 is generally rectiplanar along a plane defined by axial direction 230 and lateral direction 232. In some arrangements, the flat sheet 203 is held in the folded or pleated position to form a pleat block or pack. The fold lines 213 extend axially along the lateral direction 232. A sealing component 233 is used to seal the small transition area between the alternative pleat seals and extends around the entire perimeter of the media pack. An example of the seal bead pattern 250 is shown in FIG. 24. FIG. 24 shows two views of media with adhesive beads added to create a filter element of diagonal flow design. Adhesive bead on the left side of the cross-sectional view is shown applied to a felt side of the media and the adhesive bead on the right side is shown applied to a wire side of the media. In FIG. 24, the solid line 251 depicts an adhesive bead positioned on an upper side of the media and the dashed line 253 depicts an adhesive bead 252 positioned on a bottom side of the media. In some embodiments, the sealing component 233 is formed of foamed polyurethane. In some embodiments, the width of the seal is approximately 10 to 50 millimeters (mm). In some embodiments, a polymer frame sealed to the media pack may be used. In some arrangements, the media surface density is at least 10 per inch or the pleat concentration is at least 5 pleats per inch. In other arrangements, the media surface density is at least 14 per inch or the pleat concentration is at least 7 pleats per inch. In yet another arrangement, the media surface density is at least 18 per inch or the pleat concentration is at least 9 pleats per inch.

The filter media 201 comprises a plurality of filter media wall segments 223 extending between the fold lines 213. The wall segments 223 extend axially and define axial flow channels therebetween. As shown in FIG. 17, in some arrangements, the filter element 200 includes a sidewall 210 completely enclosing the filter media 201 on four sides. The filter media 201 has a first inlet face 202 receiving incoming dirty fluid (as shown at arrow 212), and a first outlet face 204 discharging clean filtered fluid as shown at arrow 214. Referring to FIG. 17, in some arrangements, the filter element 200 includes a single inlet face 202 positioned on a first side of the filter media 201 and a single outlet face 204 on a second side of the filter media 201. Incoming dirty fluid 212 to be filtered flows along axial direction 230 into flow channels at first inlet face 202 and passes laterally along lateral direction 234 through the filter media wall segments 223, and exits as clean filtered fluid 214 through flow channels at first outlet face 204. As described further herein, in various other arrangements, the first inlet face 202 and the first outlet face 204 can be variously arranged on the filter element 200 and one or more upstream inlet and downstream outlet faces can be included with the filter element 200.

Referring to FIG. 18, a filter element 205 with a different flow structure is shown, according to an example embodiment. The filter media 201 includes a first inlet face 202, a second inlet face 206, and a third inlet face 208. The filter media 201 also includes a first outlet face 204. Unlike FIG. 17 where the filter media 201 is enclosed on four sides by a sidewall 210, the sides of the pleats of the filter media 201 in FIG. 18 are open. Accordingly, the inlet face area is increased relative to the in-line design shown in FIG. 17. In this way, restriction may be reduced by approximately 13 percent. The first inlet face 202 receives incoming dirty fluid 212, the second inlet face 206 receives incoming dirty fluid 216, and the third inlet receives incoming dirty fluid 218. The first outlet face 204 discharges clean filtered fluid 214. The angle (e.g., a 90-degree angle) between the second inlet face 206 (and third inlet face 208) and outlet flow at first outlet face 204 allows large dust particles to move out of the filter media 201 and be collected elsewhere, which leads to increased dust holding capacity and filter life. In addition, the filter housing pressure drop is minimized due to the avoidance of fluid flow turning at a high velocity. The filter media can also be packed into an otherwise void volume within the housing and dust stratification and storage at spaces with no blockage of media surface may eliminate the need for inertial separators. Furthermore, it is not necessary to use the filter media in a cylindrically-shaped housing, which may be beneficial because the cuboid shape allows for more filtration area.

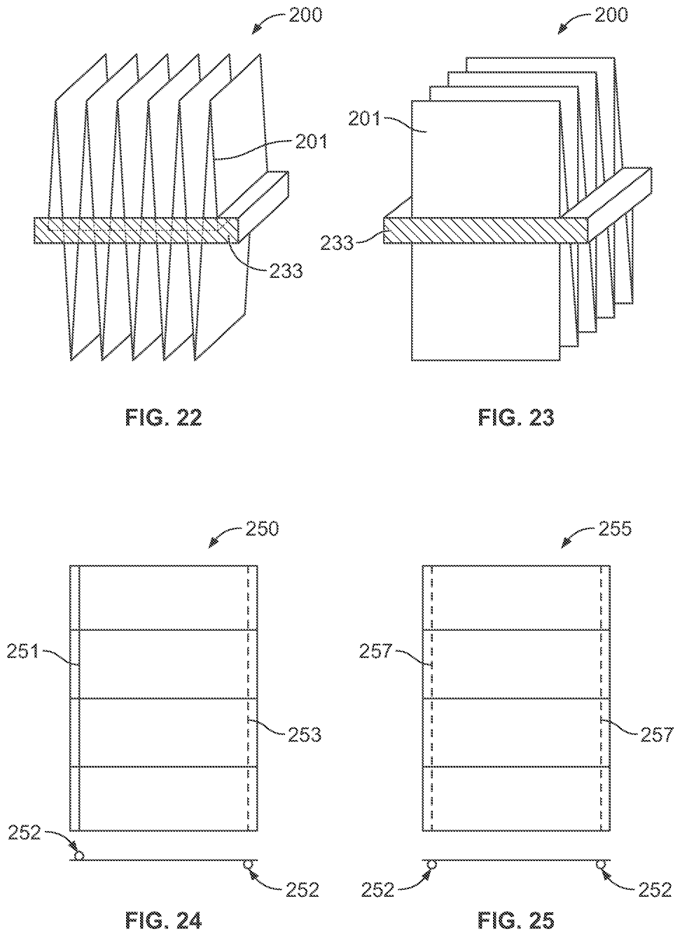

Referring to FIG. 19, a filter element 215 with a different flow structure is shown, according to an example embodiment. The filter media 201 includes a first inlet face 202, a second inlet face 206, and a third inlet face 208. The filter media 201 also includes a first outlet face 204, a second outlet face 236, and a third outlet face 238. The first inlet face 202 receives incoming dirty fluid 212, the second inlet face 206 receives incoming dirty fluid 216, and the third inlet face 208 receives incoming dirty fluid 218. The first outlet face 204 discharges clean filtered fluid 214, the second outlet face 236 discharges clean filtered fluid 226, and the third outlet face 238 discharged clean filtered fluid 228. The first inlet face 202, the second inlet face 206, and the third inlet face 208 combine to form the inlet of the filter element 200. The first outlet face 204, the second outlet face 236, and the third outlet face 238 combine to form the outlet of the filter element 200. An intermediate sealing member 233 is positioned between the inlet and the outlet faces of the filter element 200 and substantially parallel to the primary flow faces (e.g., substantially parallel to the first inlet face 202 and the first outlet face 204). An example of the positioning of the sealing component 233 in this embodiment is shown in FIGS. 22 and 23. FIG. 22 illustrated an orthographic view of a flexible flow filter element with an end view of pleats in-plane. FIG. 23 illustrates an orthographic view of a flexible flow filter element with a side view of pleats in-plane. In this embodiment, the filter element includes a mid-plane seal. In this embodiment, the inlet and outlet face areas are increased and are equal to each other. This arrangement results in an 18 percent reduction in restriction versus the in-line design shown in FIG. 17.

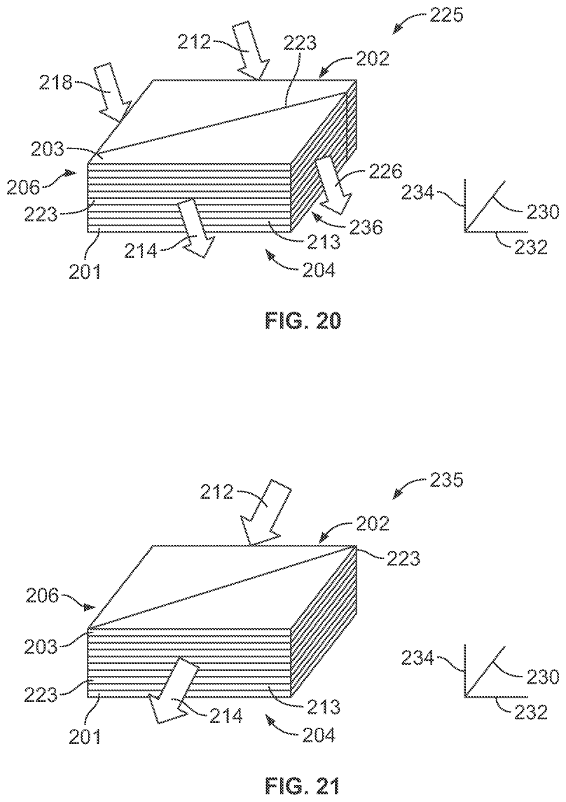

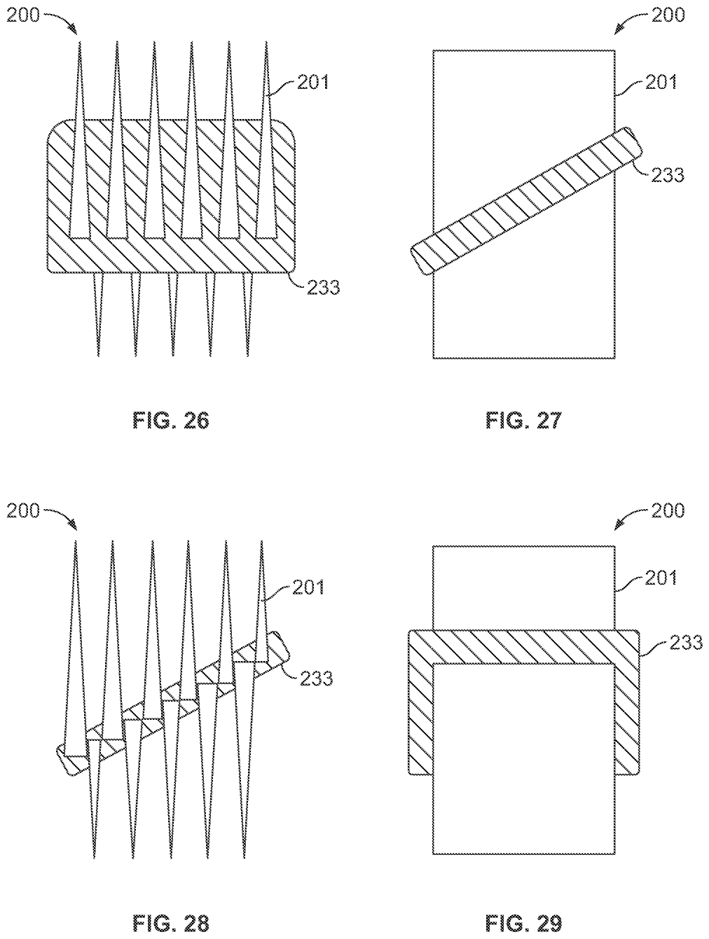

Referring to FIG. 20, a filter element 225 with a different flow structure is shown, according to an example embodiment. The filter media 201 includes a first inlet face 202 and a second inlet face 206. The filter media 201 also includes a first outlet face 204 and a second outlet face 236. The first inlet face 202 receives incoming dirty fluid 212 and the second inlet face 206 receives incoming dirty fluid 218. The first outlet face 204 discharges clean filtered fluid 214 and the second outlet face 236 discharges clean filtered fluid 226. The first inlet face 202 and the second inlet face 206 combine to form the inlet of the filter element 200. The first outlet face 204 and the second outlet face 236 combine to form the outlet of the filter element 200. An intermediate sealing component 233 is provided between the inlet and the outlet faces of the filter element 200 and is angled relative to the primary flow faces (e.g., substantially parallel to the first inlet face 202 and the first outlet face 204). In some embodiments, the intermediate sealing component 233 may be positioned in a curvilinear plane between the inlet and the outlet faces of the filter element 200. In this embodiment, the inlet and outlet face areas are increased relative to the embodiment shown in FIG. 17 and are equal to each other. FIG. 21 shows a similar embodiment, but with the intermediate sealing component 233 extending from one corner of the filter media 201 to another corner of the filter media 201. The arrangements shown in FIGS. 20 and 21 result in increased inlet, outlet, and transition area faces and result in approximately 21 percent lower restriction versus the in-line design shown in FIG. 17. The intermediate sealing component 233 provides greater flexibility in housing design and port orientation relative to a direct flow design. An example of the seal bead pattern 255 is shown in FIG. 25. FIG. 25 shows two views of media with adhesive beads added to create a filter element of flexible flow design, with a mid-plane seal. As an example, the adhesive beads 252 may alternate between the wire and felt sides of the media. In FIG. 25, the dashed lines 257 depict adhesive beads 252 positioned on a bottom side of the media. An example of the positioning of the sealing component 233 in this embodiment is shown in FIGS. 26-29.

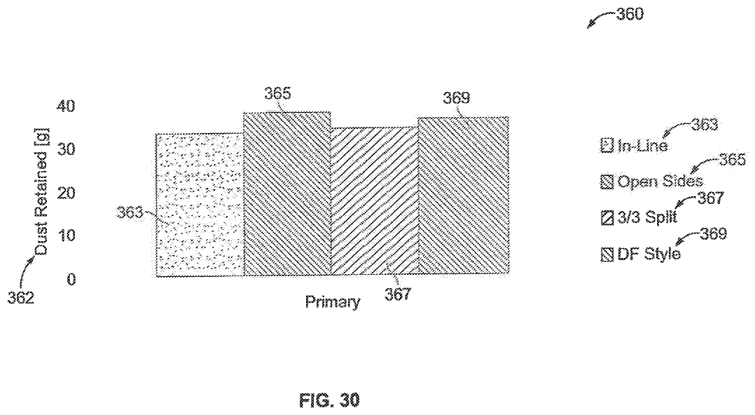

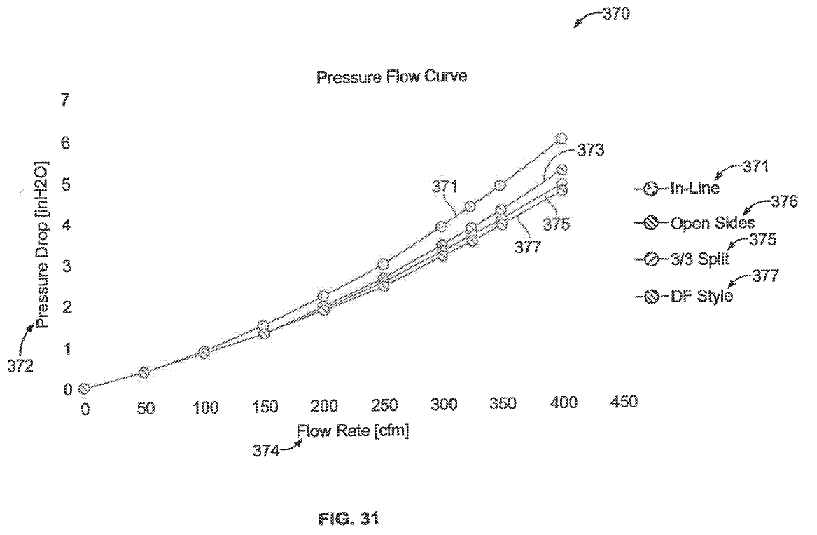

Referring to FIG. 30, a bar graph 360 illustrating the dust capacity 362 of each of the types of filter elements described in FIGS. 17-21 is shown. For example, for an in-line type filter element (as shown in FIG. 17), the dust retention 363 may be lowest at approximately 32 grams (g). Further, for an open sides type filter element (as shown in FIG. 18), the dust retention 365 may be highest at approximately 38 g. Further, for a 3-3 split type filter element (as shown in FIG. 19), the dust retention 367 may be approximately 34 g and for a direct flow style (as shown in FIGS. 20-21), the dust retention 369 may be approximately 36 g.

Referring to FIG. 31, a line graph 370 illustrating the pressure drop 372 at different flow rates 374 for each of the types of filter elements described in FIGS. 17-21 is shown. For example, for an in-line type filter element 371 (as shown in FIG. 17), the pressure drop increases at the fastest rate as flow rate increases of all the filter types. The open sides type filter element 373 exhibits approximately a 13 percent decrease in pressure drop, the 3-3 split type filter element 375 exhibits approximately an 18 percent decrease in pressure drop, and the direct flow types filter element 377 exhibits approximately a 21 percent decrease in pressure drop across flow rates.

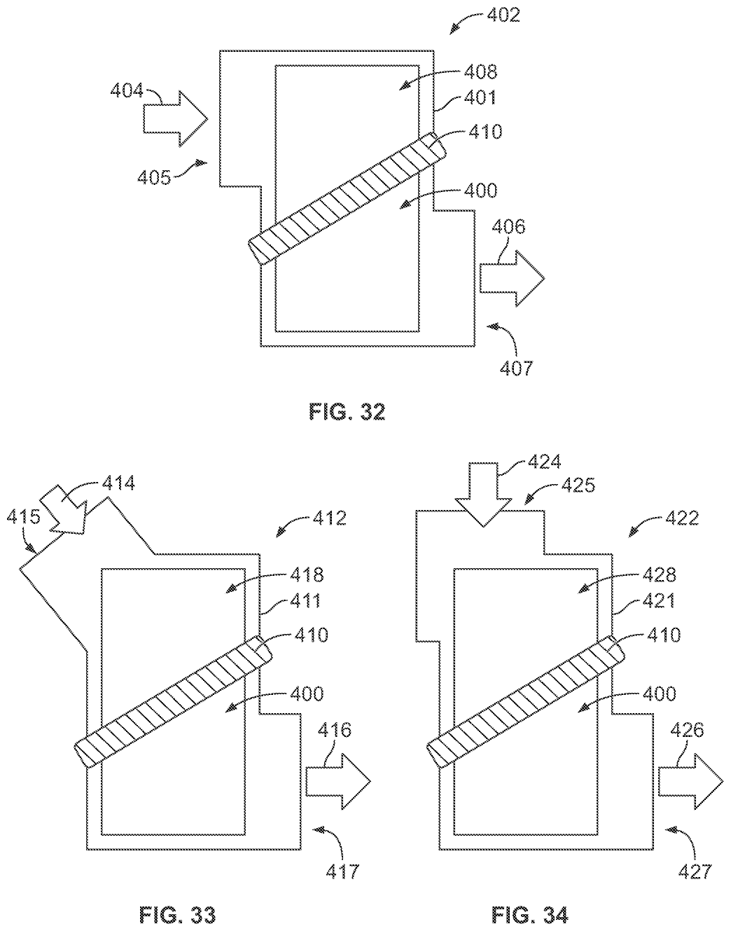

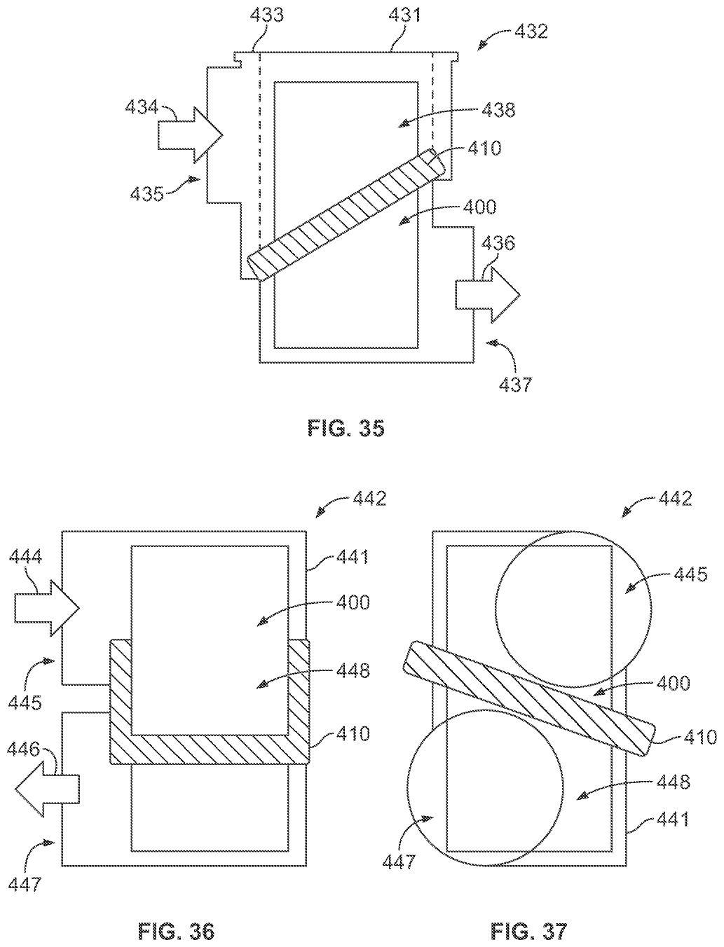

Referring to FIGS. 32-37, filter elements 400 with different airflow path arrangements are shown, according to example embodiments. The filter elements 400 use an angled seal component 410 and may reflect the different airflow path arrangements that can be used with the filter elements shown in FIGS. 20 and 21. Referring to FIG. 32, a filter element 400 with a filter housing 401 forming a flow arrangement 402 is shown, according to an example embodiment. Incoming dirty fluid 404 enters the inlet 405 on one side of the filter housing 401, flows through the filter media 408, and exits the outlet 407 as clean filtered fluid 406. The incoming dirty fluid 404 enters the housing 401 in the same direction as (e.g., substantially parallel to) the clean filtered fluid 406 exiting the housing 401. The filter element 400 includes an angled seal component 410. The inlet 405 and outlet 407 may be reversed such that the flow is reversed through the housing 401. Referring to FIG. 35, a side-load design 432 is shown with a similar airflow path arrangement. The filter element 400 shown in FIG. 35 includes a filter housing 431 with a side load portion 433 configured to be opened to maintain and replace the filter element 400. Similar to the arrangement shown in FIG. 32, incoming dirty fluid 434 enters the inlet 435 on one side of the filter housing 431, flows through the filter media 438, and exits the outlet 437 as clean filtered fluid 436. The incoming dirty fluid 434 enters the housing 431 in the same direction as (e.g., substantially parallel to) the clean filtered fluid 436 exiting the housing 431.

Referring to FIG. 33, a filter element 400 with a filter housing 411 forming a flow arrangement 412 is shown, according to an example embodiment. Incoming dirty fluid 414 enters the inlet 415 on one side of the filter housing 411, flows through the filter media 418, and exits the outlet 417 as clean filtered fluid 416. The incoming dirty fluid 414 enters the housing 411 in a corner of the filter housing 411 in a diagonal direction and the clean filtered fluid 416 exits the housing 411 on a side of the filter housing 411. In this way, the incoming dirty fluid 414 enters the housing 411 at an angle relative to the clean filtered fluid 416 exiting the housing 411. The filter element 400 includes an angled seal component 410. The inlet 415 and outlet 417 may be reversed such that the flow is reversed through the housing 411.

Referring to FIG. 34, a filter element 400 with a filter housing 421 forming a flow arrangement 422 is shown, according to an example embodiment. Incoming dirty fluid 424 enters the inlet 425 on one side of the filter housing 421, flows through the filter media 428, and exits the outlet 427 as clean filtered fluid 426. The incoming dirty fluid 424 enters the housing 421 on a shorter side of the filter housing 421 in an axial flow direction and the clean filtered fluid 426 exits the housing 421 on a longer side of the filter housing 421 in a lateral flow direction. In this way, the incoming dirty fluid 424 enters the housing 421 at a 90 degree angle relative to the clean filtered fluid 426 exiting the housing 421. The filter element 400 includes an angled seal component 410. The inlet 425 and outlet 427 may be reversed such that the flow is reversed through the housing 421.

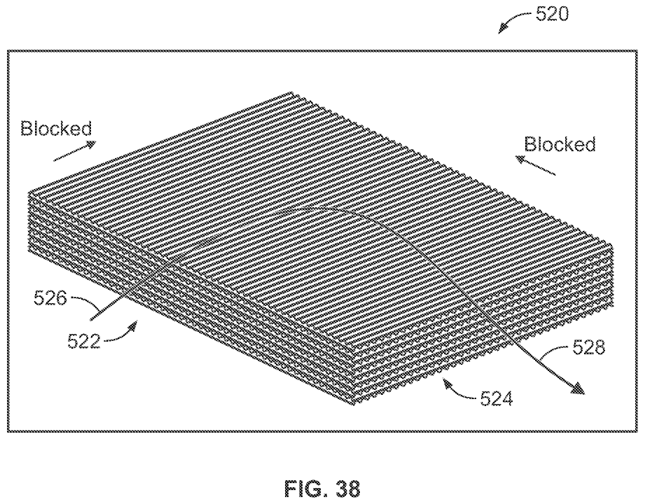

Referring to FIGS. 36-37, a filter element 400 with a filter housing 441 forming a flow arrangement 442 is shown, according to an example embodiment. Incoming dirty fluid 444 enters the inlet 445 on one side of the filter housing 441, flows through the filter media 448 (e.g., making a full 180 degree turn), and exits the outlet 447 as clean filtered fluid 446 on the same side of the housing 441. The incoming dirty fluid 444 enters the housing 441 in a direction opposite to (e.g., 180 degrees from) the clean filtered fluid 446 exiting the housing 441. The filter element 400 includes an angled seal component 410. The inlet 445 and outlet 447 may be reversed such that the flow is reversed through the housing 441.

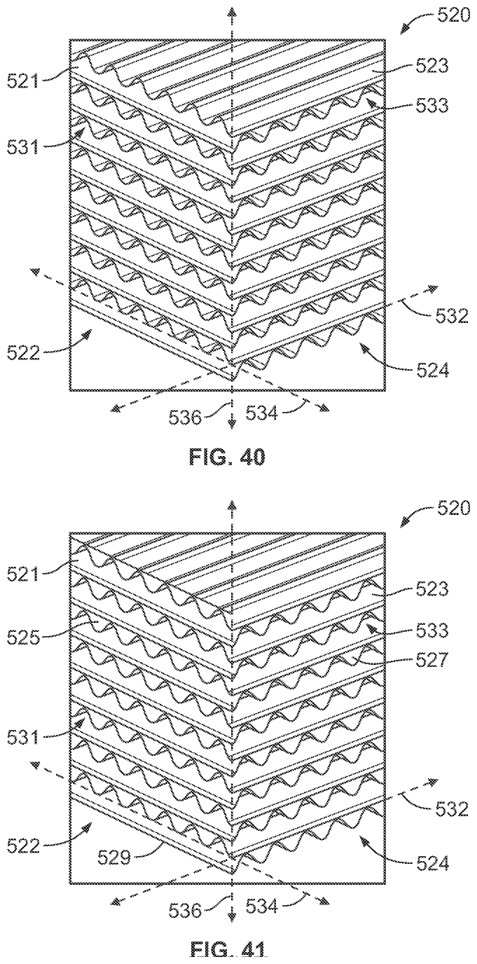

Referring to FIGS. 38-41, filter media 520 is shown using stacked corrugated sheets stacked at 90 degrees relative to each other, according to an example embodiment. The filter media 520 is sealed on the sides and at alternate ends so as to guide airflow through the filter media 520 to turn 90 degrees through the media sheets. Referring to FIG. 38, incoming dirty fluid 526 enters the filter media 520 at an upstream inlet face 522, flows through the filter media 520, changes direction by 90 degrees, and exits the filter media 520 as clean filtered fluid 528 at a downstream outlet face 524.

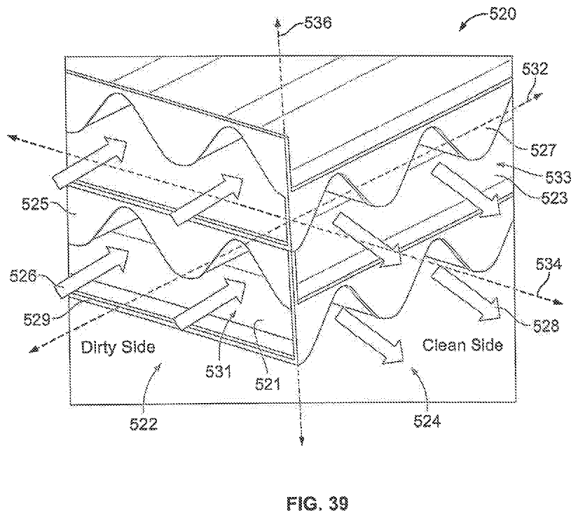

Referring to FIGS. 39-41, first corrugated sheets 523 are stacked in a first direction 532 and second corrugated sheets 521 are stacked in a second direction 534. The first direction 532 is approximately 90 degrees (e.g., approximately perpendicular) to the second direction 534. The first corrugated sheets 523 are alternatingly stacked with and neighboring the second corrugated sheets 521, such that a first corrugated sheet 523 is always stacked on top of and below a second corrugated sheet 521 and similarly, a second corrugated sheet 521 is always stacked on top of and below a first corrugated sheet 523. In some embodiments, a frame 529 supports the arrangement of the first corrugated sheets 523 and the second corrugated sheets 521 in this position. The first corrugated sheets 523 and the second corrugated sheets 521 are the same type of corrugated sheet and the denotation of “first” and “second” as described herein is for clarity purposes. The stacking of the first corrugated sheets 523 and the second corrugated sheets 521 form first flow channels 531 on the inlet dirty side and second flow channels 533 on the outlet clean side that are approximately 90 degrees relative to each other. A portion of the first flow channels 531 are sealed by a first sealing component 525 thereby blocking fluid flow through a portion of the first flow channels 531 and a portion of the second flow channels 533 are sealed by a second sealing component 527 thereby blocking fluid flow through a portion of the second flow channels 533. As such, the fluid flow is guided through the filter media 520 in a 90 degree turn and the fluid is filtered simultaneously. Accordingly, incoming dirty fluid 526 enters first flow channels 531 in a first direction 532 and clean filtered fluid 528 exits the filter media 520 from second flow channels 533 in a second direction 534. By the nature of the fluid flow, the fluid is forced to flow through the neighboring corrugated sheet in a direction at or at an angle relative to a third direction 536. The third direction 536 is approximately 90 degrees from both the first direction 532 and the second direction 534.

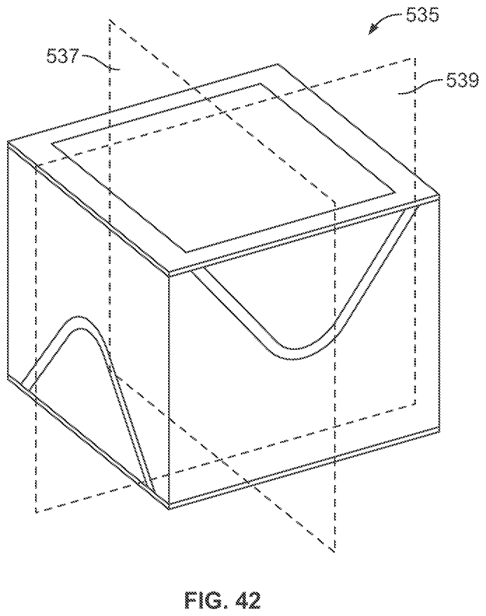

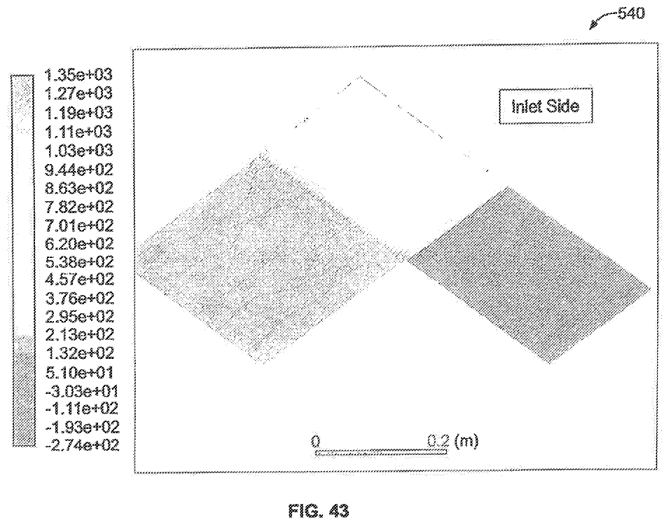

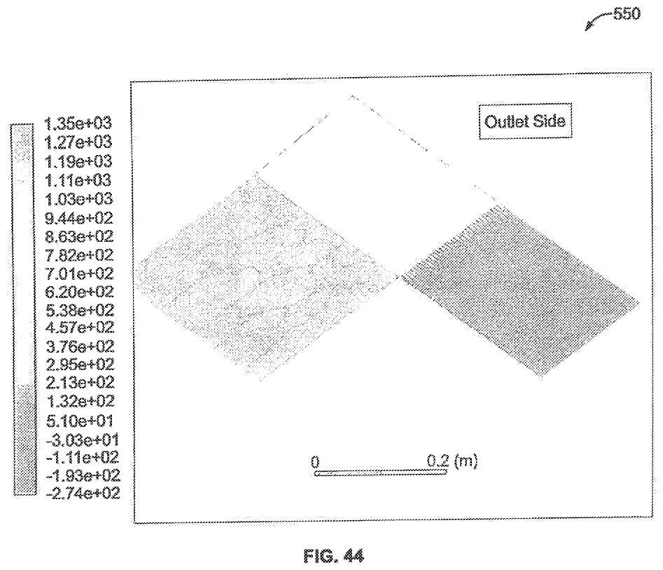

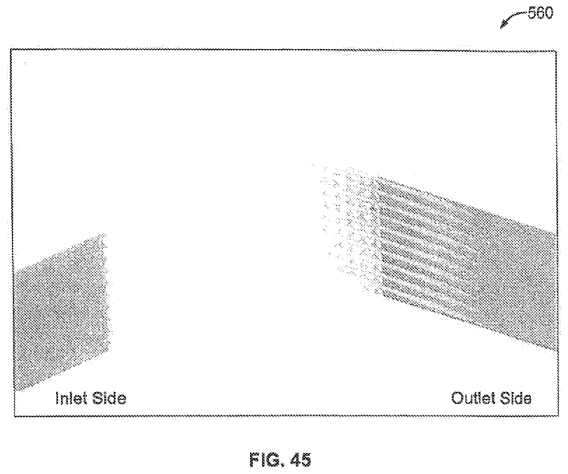

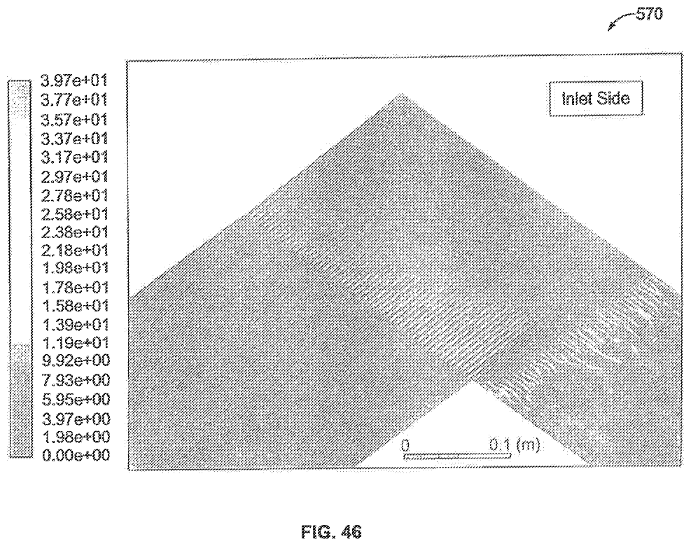

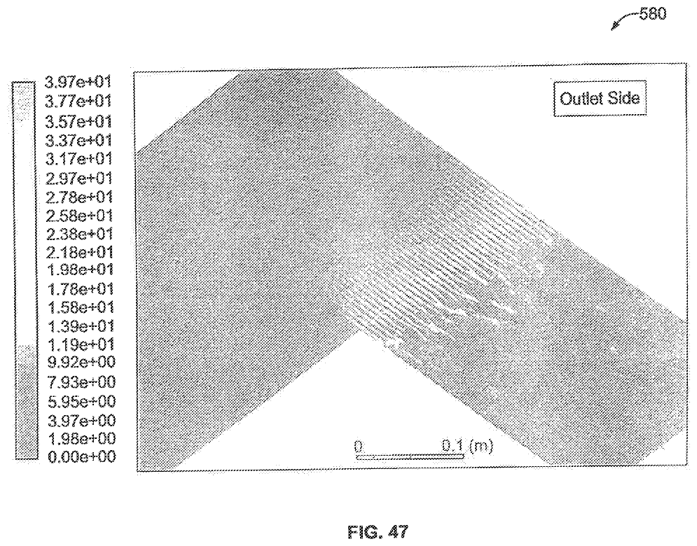

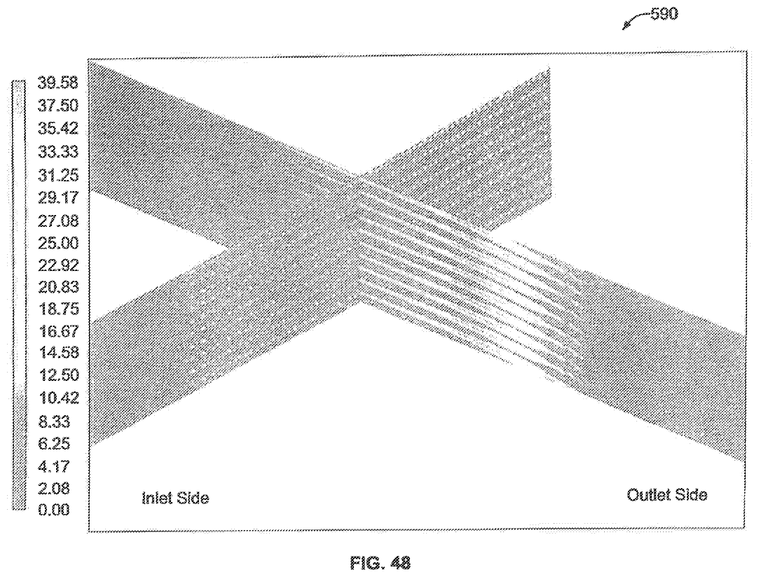

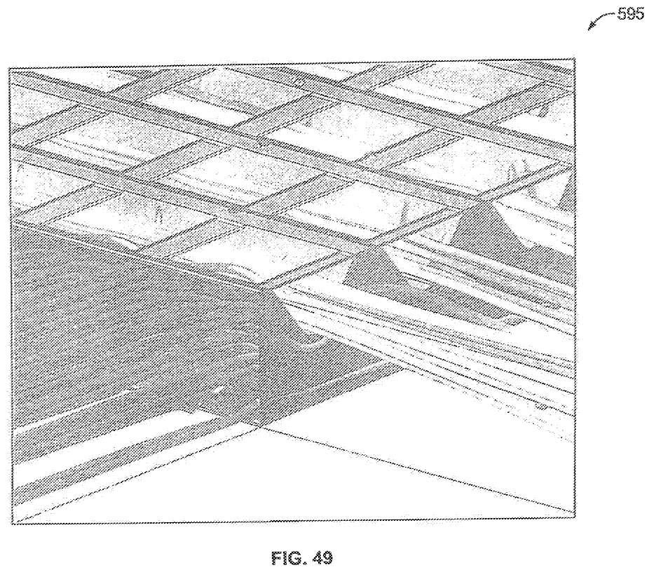

Referring to FIG. 42, an isolated single corrugation volume 535 is shown, which is used in modeling the computational fluid dynamics analyses described further herein. A first mirror plane 537 and a second mirror plane 539 each dissecting a cross-section (e.g., perpendicular or 90 degrees apart) of the isolated single corrugation volume 535 are used to simplify the modeling of the pressure and flow diagrams described herein. Referring to FIGS. 43-45, total pressure contours on the inlet side 540, the outlet side 550, and a combined model 560 are shown. Referring to FIGS. 46-49, velocity magnitude contours on the inlet side 570, the outlet side 580, and a combined model 590 are shown. Referring to FIG. 49, streamlines visualized at a corner of the filter media 520 connecting the neighboring sides of the filter media 520 are shown.

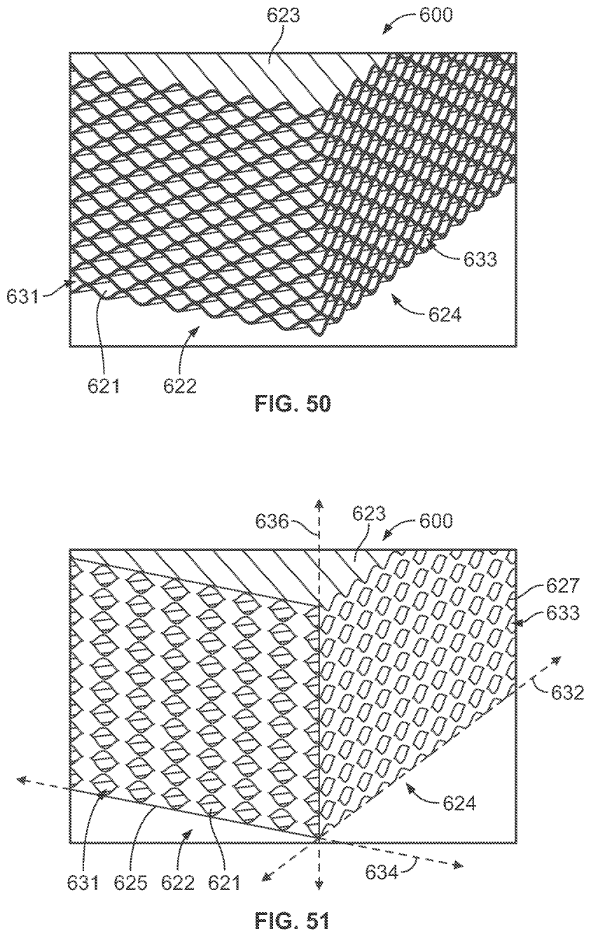

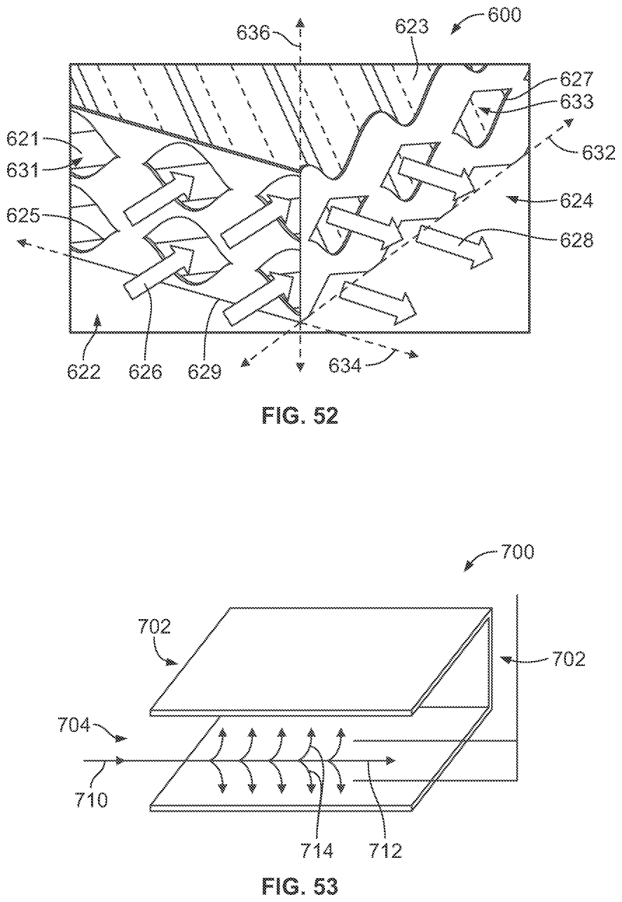

Referring to FIGS. 50-52, filter media 600 is shown using stacked corrugated sheets stacked at 90 degrees relative to each other, according to an example embodiment. The corrugated sheets have diagonal corrugations. The filter media 600 is sealed on the sides and at alternate ends so as to guide airflow through the filter media 600 to turn 90 degrees through the media sheets. Referring to FIG. 52, incoming dirty fluid 626 enters the filter media 600 at an upstream inlet face 622, flows through the filter media 600, changes direction by 90 degrees, and exits the filter media 600 as clean filtered fluid 628 at a downstream outlet face 624.

The first corrugated sheets 623 are stacked in a first direction 632 and second corrugated sheets 621 are stacked in a second direction 634. The first direction 632 is approximately 90 degrees (e.g., approximately perpendicular) to the second direction 634. The corrugations of the first corrugated sheets 623 are positioned approximately 45 degrees between the first direction 632 and the second direction 634 and the corrugations of the second corrugated sheets 621 are positioned approximately 90 degrees from the corrugations of the first corrugated sheets 623. The first corrugated sheets 623 are alternatingly stacked with and neighboring the second corrugated sheets 621, such that a first corrugated sheet 623 is always stacked on top of and below a second corrugated sheet 621 and similarly, a second corrugated sheet 621 is always stacked on top of and below a first corrugated sheet 623. In some embodiments, a frame 629 supports the arrangement of the first corrugated sheets 623 and second corrugated sheets 621 in this position. The first corrugated sheets 623 and the second corrugated sheets 621 are the same type of diagonally corrugated sheet and the denotation of “first” and “second” as described herein is for clarity purposes. The stacking of the first corrugated sheets 623 and the second corrugated sheets 621 form first flow channels 631 on the inlet dirty side and second flow channels 633 on the outlet clean side that are approximately 90 degrees relative to each other. A portion of the first flow channels 631 are sealed by a first sealing component 625 thereby blocking fluid flow through a portion of the first flow channels 631 and a portion of the second flow channels 633 are sealed by a second sealing component 627 thereby blocking fluid flow through a portion of the second flow channels 633. As such, the fluid flow is guided through the filter media 620 in a 90 degree turn and the fluid is filtered simultaneously. Accordingly, and as shown in FIG. 52, incoming dirty fluid 626 enters into first flow channels 631 in a first direction 632 and clean filtered fluid 628 exits the filter media 600 from second flow channels 633 in a second direction 634. By the nature of the fluid flow, the fluid is forced to flow through the neighboring corrugated sheet in a direction at or at an angle relative to a third direction 636. The third direction 636 is approximately 90 degrees from both the first direction 632 and the second direction 634.

It should be noted that any use of the term “example” herein to describe various embodiments is intended to indicate that such embodiments are possible examples, representations, and/or illustrations of possible embodiments (and such term is not intended to connote that such embodiments are necessarily extraordinary or superlative examples).

References herein to the positions of elements (e.g., “top,” “bottom,” etc.) are merely used to describe the orientation of various elements in the FIGURES. It should be noted that the orientation of various elements may differ according to other example embodiments, and that such variations are intended to be encompassed by the present disclosure.

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Additionally, features from particular embodiments may be combined with features from other embodiments as would be understood by one of ordinary skill in the art. Other substitutions, modifications, changes and omissions may also be made in the design, operating conditions and arrangement of the various example embodiments without departing from the scope of the present invention.

1. Filter media comprising:
a filter media pack with upstream or downstream media surface density of at least 14 per inch, or being a pleated media pack with a pleat concentration is at least 7 pleats per inch, the filter media pack further comprising an upstream inlet receiving dirty fluid along a first direction and a downstream outlet discharging clean fluid along a second direction, the second direction substantially not parallel to the first direction; and
a separation geometry feature or a separation mechanism comprising a spacer mesh structure positioned between adjacent pleats and comprising a plurality of main strands connected to each other by a plurality of connecting strands.

2. The filter media of claim 1, wherein the upstream or downstream media surface density is at least 18 per inch, or the pleat concentration is at least 9 pleats per inch for pleated filter media packs.

3. The filter media of claim 1, wherein at least 20 percent of large dust particles misses the downstream outlet, thereby allowing dust to move out of a media pack of the filter media when the fluid flows straight from the upstream inlet in the first direction.

4. The filter media of claim 1, wherein at least 30 percent of large dust particles misses the downstream outlet, thereby allowing dust to move out of a media pack of the filter media when the fluid flows straight from the upstream inlet in the first direction.

5. The filter media of claim 1, wherein at least 50 percent of large dust particles misses the downstream outlet, thereby allowing dust to move out of a media pack of the filter media when the fluid flows straight from the upstream inlet in first direction.

6. The filter media of claim 1, wherein the filter media pack comprises a flat sheet of filter media that is alternately folded along a plurality of pleat fold lines.

7. The filter media of claim 1, wherein the separation geometry feature or the separation mechanism maintains a separation distance between adjacent pleats of the filter media.

8. The filter media of claim 7, wherein the separation geometry feature comprises a plurality of embossments, each of the plurality of embossments extend in a direction that is perpendicular to an axis defined by a pleat fold line of the plurality of pleat fold lines.

9. The filter media of claim 7, wherein the spacer mesh structure comprises an inlet spacer mesh structure positioned between adjacent pleats, the inlet spacer mesh structure comprising a plurality of inlet main strands connected to each other by a plurality of inlet connecting strands, the plurality of inlet main strands substantially parallel to the first direction.

10. The filter media of claim 7, wherein the spacer mesh structure comprises an outlet spacer mesh structure positioned between adjacent pleats, the outlet spacer mesh structure comprising a plurality of outlet main strands connected to each other by a plurality of outlet connecting strands, the plurality of outlet main strands substantially parallel to the second direction.

11. The filter media of claim 7, wherein the separation mechanism comprises adhesive bead separators, each of the plurality of adhesive beads extend in a direction that is perpendicular to an axis defined by a pleat fold line of the plurality of pleat fold lines.

12. Filter media comprising:
a filter media pack with an upstream inlet receiving dirty fluid along a first direction; and
a downstream outlet discharging clean fluid along a second direction, the second direction substantially not parallel to the first direction;
the filter media further comprising a separation geometry feature or a separation mechanism that maintains a separation distance between adjacent pleats of the filter media, the separation geometry feature comprising a plurality of adhesive bead separators, each of the plurality of adhesive bead separators extend in a direction that is perpendicular to an axis defined by a pleat fold line of a plurality of pleat fold lines.

13. (canceled)

14. The filter media of claim 12, wherein the separation mechanism comprises an inlet spacer mesh structure positioned between adjacent pleats, the inlet spacer mesh structure comprising a plurality of inlet main strands connected to each other by a plurality of inlet connecting strands, the plurality of inlet main strands substantially parallel to the first direction.

15. The filter media of claim 12, wherein the separation mechanism comprises an outlet spacer mesh structure positioned between adjacent pleats, the outlet spacer mesh structure comprising a plurality of outlet main strands connected to each other by a plurality of outlet connecting strands, the plurality of outlet main strands substantially parallel to the second direction.

16. (canceled)

17. The filter media of claim 12, wherein at least 20 percent of large dust particles misses the downstream outlet, thereby allowing dust to move out of a media pack of the filter media when the fluid flows straight from the upstream inlet in the first direction.

18. The filter media of claim 12, wherein at least 30 percent of large dust particles misses the downstream outlet, thereby allowing dust to move out of a media pack of the filter media when the fluid flows straight from the upstream inlet in the first direction.

19. The filter media of claim 12, wherein at least 50 percent of large dust particles misses the downstream outlet, thereby allowing dust to move out of a media pack of the filter media when the fluid flows straight from the upstream inlet in first direction.

20. Filter media comprising:
a flat sheet of filter media that is alternately folded along a plurality of pleat fold lines, the flat sheet of filter media comprising a separation geometry feature or a separation mechanism that maintains a separation distance between adjacent pleats of the filter media;
an upstream inlet receiving dirty fluid along a first direction;
a downstream outlet discharging clean fluid along a second direction, an angle between the second direction and the first direction less than 180 degrees and greater than zero degrees; and
a plurality of wall segments extending between the plurality of pleat fold lines, wherein fluid flows along the first direction into flow channels and passes laterally through the plurality of wall segments along the second direction.

21. The filter media of claim 20, wherein the pleat concentration is at least 7 pleats per inch.

22. The filter media of claim 20, wherein the pleat concentration is at least 9 pleats per inch.

23. The filter media of claim 20, wherein at least 20 percent of large dust particles misses the downstream outlet, thereby allowing dust to move out of a media pack of the filter media when the fluid flows straight from the upstream inlet in the first direction.

24. The filter media of claim 20, wherein at least 30 percent of large dust particles misses the downstream outlet, thereby allowing dust to move out of a media pack of the filter media when the fluid flows straight from the upstream inlet in the first direction.

25. The filter media of claim 20, wherein at least 50 percent of large dust particles misses the downstream outlet, thereby allowing dust to move out of a media pack of the filter media when the fluid flows straight from the upstream inlet in first direction.

26. Filter media comprising:
a flat sheet of filter media that is alternately folded along a plurality of pleat fold lines;
a first upstream inlet face receiving dirty fluid along a first inlet direction and a second upstream inlet face receiving dirty fluid along a second inlet direction, the first upstream inlet face and the second upstream inlet face combining to form an inlet of the filter media;
a first downstream outlet face discharging clean fluid along a first outlet direction and a second downstream outlet face discharging clean fluid along a second outlet direction, the first downstream outlet face and the second downstream outlet face combining to form an outlet of the filter media; and
an intermediate seal member positioned between the inlet and the outlet;
wherein the first inlet direction and the first outlet direction are substantially parallel to each other.

27. The filter media of claim 26, wherein the second inlet direction and the second outlet direction are substantially parallel to each other.

28. The filter media of claim 27, wherein the first inlet direction, the first outlet direction, the second inlet direction, and the second outlet direction are all substantially parallel to each other.

29. The filter media of claim 26, wherein the first inlet direction and the first outlet direction and parallel to each other and the second inlet direction and the second outlet direction are substantially perpendicular to each other.

30. The filter media of claim 26, wherein the intermediate seal member is parallel to the first upstream inlet face and the first downstream outlet face.

31. The filter media of claim 26, further comprising an intermediate seal member positioned between the inlet and the outlet and at an angle relative to the first upstream inlet and the first downstream outlet.

32. The filter media of claim 31, wherein the intermediate seal member is positioned at or more than 45 degrees from the first upstream inlet face.

33. The filter media of claim 26, further comprising an intermediate seal member positioned in a curvilinear plane between the inlet and the outlet.

34. Filter element comprising:
a first set of corrugated sheets positioned in a first direction;
a second set of corrugated sheets positioned in a second direction, each piece of first set of corrugated sheets and each piece of the second set of corrugated sheets alternatingly stacked on top of each other;
a first set of flow channels formed along the first direction and are sealed on particular sides of the element, incoming dirty fluid entering and flowing through the first set of flow channels and through the second set of corrugated sheets in a third direction; and
a second set of flow channels formed along the second direction and are sealed on particular sides of filter element, clean filtered fluid exiting the filter media through the second set of flow channels.

35. The filter element of claim 34, wherein the first direction is substantially perpendicular to the second direction.

36. The filter element of claim 34, further comprising a frame supporting the first set of corrugated sheets and the second set of corrugated sheets.

37. The filter element of claim 34, wherein the third direction is substantially perpendicular to the first direction and the second direction.

38. The filter element of claim 34, wherein the first set of corrugated sheets and the second set of corrugated sheets comprise diagonal corrugations, the diagonal corrugations aligned approximately 45 degrees between the first direction and the second direction.

39. A filter element comprising:
a filter media pack comprising an upstream or downstream media surface density of at least 14 per inch, or being a pleated media pack with a pleat concentration is at least 7 pleats per inch, the filter media pack further comprising an upstream inlet receiving dirty fluid along a first direction and a downstream outlet discharging clean fluid along a second direction, the second direction substantially not parallel to the first direction;
wherein the filter media pack is positioned inside a filter housing comprising an inlet and an outlet, the inlet positioned near the inlet face of the filter media pack and outlet positioned near the outlet face of the filter media pack.

40. A filter element comprising:
a filter media pack comprising an upstream inlet receiving dirty fluid along a first direction and a downstream outlet discharging clean fluid along a second direction, the second direction substantially not parallel to the first direction and further comprising a separation geometry feature or a separation mechanism that maintains a separation distance between adjacent pleats of the filter media;
wherein the filter media pack is positioned inside a filter housing comprising an inlet and an outlet, the inlet positioned near the inlet face of the filter media pack and outlet positioned near the outlet face of the filter media pack.

41. A filter element comprising:
a filter media pack comprising an upstream or downstream media surface density of at least 14 per inch, or being a pleated media pack with a pleat concentration is at least 7 pleats per inch, the filter media pack further comprising an upstream inlet receiving dirty fluid along a first direction and a downstream outlet discharging clean fluid along a second direction, the second direction substantially not parallel to the first direction, the filter media pack further comprising a separation geometry feature or a separation mechanism that maintains a separation distance between adjacent pleats of the filter media;
wherein the filter media pack is positioned inside a filter housing comprising an inlet and an outlet, the inlet positioned near the inlet face of the filter media pack and outlet positioned near the outlet face of the filter media pack.
